(19) United States
(12) Patent Application Publication
(10) Pub. No.: US 2007/0164690 A1
(43) Pub. Date: Jul. 19, 2007

(54) DISCHARGE LAMP DRIVING DEVICE

(75) Inventors: YU-HSIAO CHAO, Tu-Cheng (TW); CHI-HSIUNG LEE, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/552,986

(22) Filed: Oct. 26, 2006

(30) Foreign Application Priority Data
Jan. 17, 2006 (CN) 200610033274.6

(51) Int. Cl. H05B 39/00

(52) U.S. Cl. 315/312

(57) ABSTRACT

A discharge lamp driving device, for driving a plurality of lamp modules (23), includes a plurality of power stage circuits (22), a plurality of driving circuits (24), a multi-phase controller (21), and a controller (25). The power stage circuits, respectively corresponding to the lamp modules, converts received direct current (DC) signals to alternating current (AC) signals to drive the corresponding lamp modules. The driving circuits, respectively connected to corresponding power stage circuits, output driving signals to control outputs of the corresponding power stage circuits. The multi-phase controller, connected to the driving circuits, controls timing of the driving circuits outputting the driving signals. The controller, connected to the driving circuits, controls duty cycles of the driving signals.

### BACKGROUND OF THE INVENTION

1. Field of the Invention

The invention relates to discharge lamp driving devices, and particularly to a discharge lamp driving device applied in a backlight module of a liquid crystal display (LCD).

2. Description of Related Art

Generally, discharge lamps have been used as backlight sources for liquid crystal display (LCD) panels. Brightness of the LCD panels is usually adjusted by use of a duty cycle control dimming method with the discharge lamps. The duty cycle control dimming method adjusts current flowing through the discharge lamps according to variable duty cycles of a pulse width modulation (PWM) wave from a controller, thereby adjusting the brightness of the LCD panels.

In larger size LCD panels, a plurality of lamps are usually provided to ensure enough brightness for the LCD panels. In order to avoid perceived variations in brightness of the LCD panels due to the lamps dimming simultaneously with fluctuations in power, a multi-phase discharge lamp driving device is provided so that the plurality of lamps do not experience the power fluctuations simultaneously.

FIG. 6 is a block diagram of a conventional multi-phase discharge lamp driving device. The conventional multi-phase discharge lamp driving device includes a multi-phase controller 11, a plurality of power stage circuits 12, a plurality of lamp modules 13, a plurality of feedback circuits 14, a plurality of pulse width modulation (PWM) controllers 15, and a plurality of driving circuits 16. The power stage circuit 12 converts a received direct current signal to an alternating current signal to drive a corresponding lamp module 13. Each feedback circuit 14 feeds back current flowing through the corresponding lamp module 13 to a corresponding PWM controller 15. Each PWM controller 15 controls an output of the corresponding power stage circuit 12 via the corresponding driving circuit 16 according to an output of the corresponding feedback circuit 14, and accordingly adjusts the current flowing to the lamp module 13. The multi-phase controller 11, connected to the PWM controllers 15, outputs control signals to control the PWM controllers 15 such that the lamp modules 13 do not start simultaneously.

Each lamp module 13 of the conventional discharge lamp driving device is respectively controlled by one PWM controller 15. Thus, the number of the PWM controllers 15 increases corresponding with any increases in the number of the lamp modules 13. Therefore, the cost of the discharge lamp driving device with a plurality of lamp modules is relatively high. In addition, because the driving device must generate synchronized signals to control the PWM controllers 15 in the same working frequency, the conventional discharge lamp driving device has a complex configuration.

### SUMMARY OF THE INVENTION

An exemplary embodiment of the present invention provides a discharge lamp driving device for driving a plurality of lamp modules. The discharge lamp driving device includes a plurality of power stage circuits, a plurality of driving circuits, a multi-phase controller, and a controller. The power stage circuits, respectively corresponding to the lamp modules, converts received direct current (DC) signals to alternating current (AC) signals to drive the corresponding lamp modules. The driving circuits, respectively connected to the corresponding power stage circuits, output driving signals to control outputs of the corresponding power stage circuits. The multi-phase controller, connected to the driving circuits, controls timing of the driving circuits outputting the driving signals. The controller, connected to the driving circuits, controls duty cycles of the driving signals.

Other advantages and novel features will become more apparent from the following detailed description when taken in conjunction with the accompanying drawings, in which:

### BRIEF DESCRIPTION OF THE DRAWINGS

FIG. 1 is a block diagram of a discharge lamp driving device of an exemplary embodiment of the present invention;

FIG. 2 is a circuit diagram of a power stage circuit and a lamp module of FIG. 1;

FIG. 3 is a block diagram of a discharge lamp driving device of another exemplary embodiment of the present invention;

FIG. 4 is a circuit diagram of a power stage circuit, a lamp module, and a feedback circuit of FIG. 3;

FIG. 5 is a block diagram of a discharge lamp driving device of a further exemplary embodiment; and

FIG. 6 is a block diagram of a conventional multi-phase discharge lamp driving device.

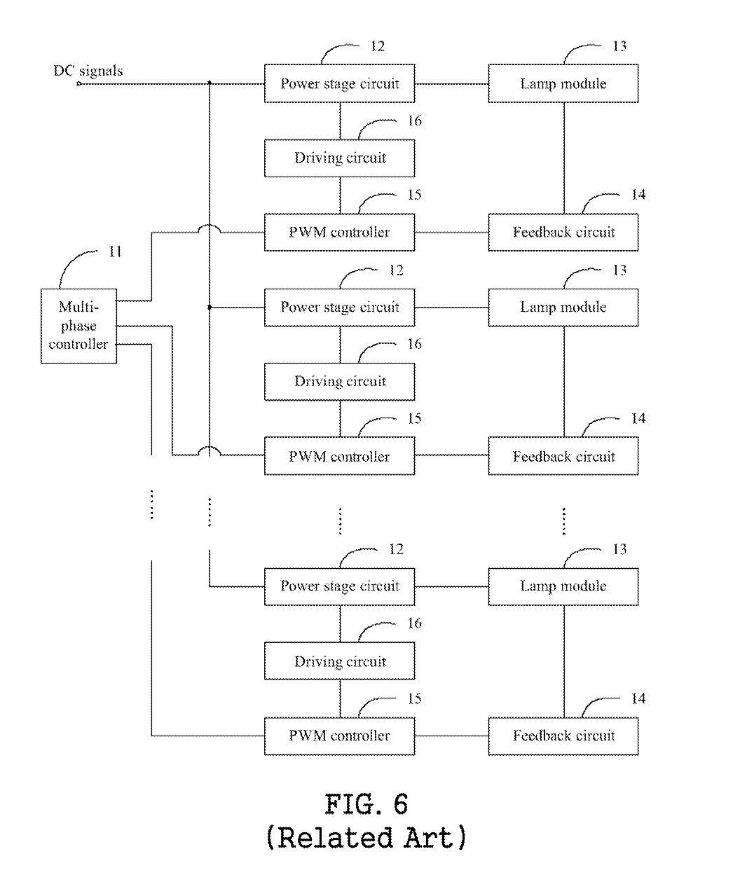

### DETAILED DESCRIPTION OF THE INVENTION

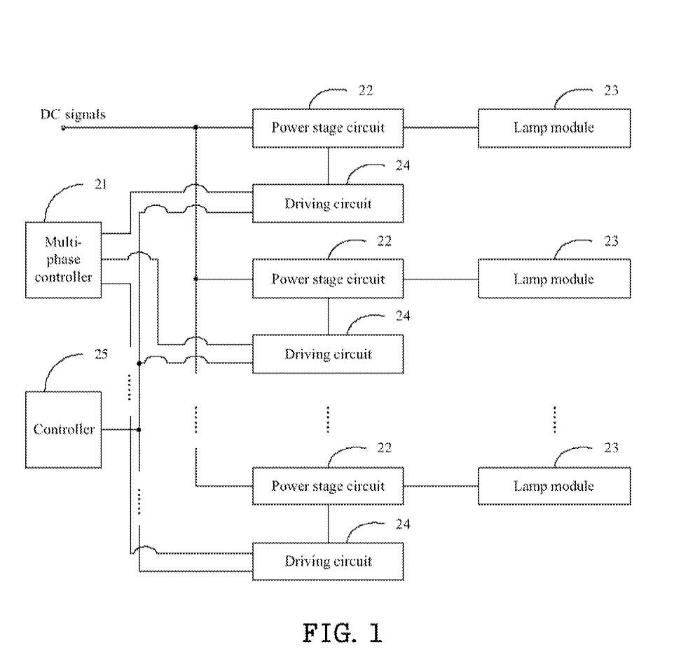

FIG. 1 is a block diagram of a discharge lamp driving device of an exemplary embodiment of the present invention. The discharge lamp driving device includes a multi-phase controller 21, a plurality of power stage circuits 22, a plurality of lamp modules 23, a plurality of driving circuits 24, and a controller 25.

Each of the power stage circuits 22, corresponding to a lamp module 23, converts received direct current (DC) signals to alternating current (AC) signals to drive the corresponding lamp module 23. Each of the driving circuits 24, connected to a corresponding power stage circuit 22, outputs driving signals to control outputs of the corresponding power stage circuit 22, thereby controlling current flowing through the corresponding lamp module 23.

In the exemplary embodiment, when the DC signals are stably provided to the lamp modules 13, the current flowing through each lamp module 23 is approximately constant. Therefore, the discharge lamp driving device of this embodiment is an open loop. In this embodiment, no feedback circuit is needed to feed back the current flowing through the lamp modules 23.

The controller 25, connected to the driving circuits 24, controls duty cycles of the driving signals output by the driving circuits 24, thereby controlling outputs of the power stage circuits 22. In the exemplary embodiment, the controller 25 may be a bus controller, which has a fixed cycle and variable frequencies. The controller 25 can control the duty cycles of the driving signals according to variable frequencies thereof. A high voltage is needed for lighting up the lamp modules 23, and a working voltage after the lamp modules 23 are turned on is lower than the voltage for lighting the lamp modules 23 up. Therefore, the working frequency of the controller 25 is higher before the lamp modules 23 are lit, and the working frequency of the controller 25 is dropped to a stable frequency after the lamp modules 23 are turned on, namely after a period predetermined by the controller 25.

The multi-phase controller 21, connected to the driving circuits 24, controls timing of the driving circuits 24 outputting the driving signals to sequentially light the lamp modules 23 so that not all the lamp modules 23 are lit simultaneously.

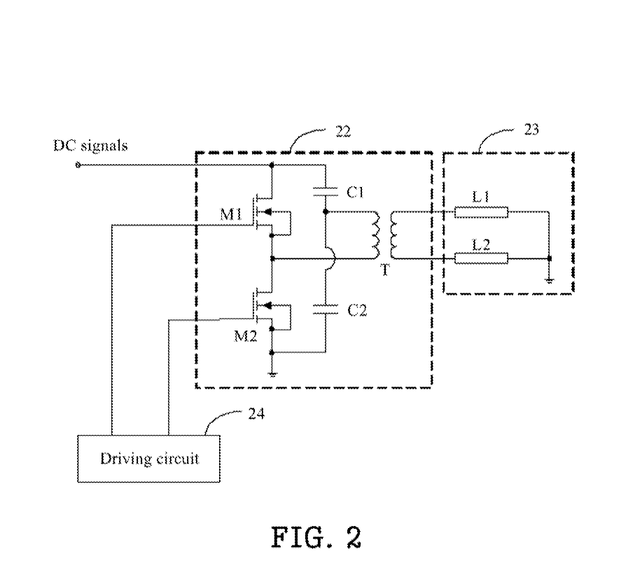

FIG. 2 is a circuit diagram of the power stage circuit 22 and the lamp module 23 of FIG. 1. In the exemplary embodiment, the power stage circuit 22 may be a half-bridge circuit. The power stage circuit 22 includes two metal-oxide-semiconductor field effect transistors (MOSFETs) M1, M2, two capacitors C1, C2, and a transformer T. A drain of the MOSFET M1 receives DC signals. A gate of the MOSFET M1 and a gate of the MOSFET M2 are both connected to the driving circuit 24. A source of the MOSFET M1 and a drain of the MOSFET M2 are jointly connected to one end of a primary winding of the transformer T. A source of the MOSFET M2 is grounded. The capacitor C1 and the capacitor C2 are connected in series between the drain of the MOSFET M1 and the source of the MOSFET M2. Another end of the primary winding of the transformer T is connected between the capacitor C1 and the capacitor C2. The lamp module 23 includes two lamps L1 and L2. The lamps L1 and L2 are respectively connected between the ground and two ends of a secondary winding of the transformer T.

In other embodiments, although detailed circuit diagrams of other embodiments are not shown, one skilled in the art may replace the half-bridge circuit with other types of power stage circuits; for example, the power stage circuit 22 may be a full-bridge circuit, a push-pull circuit, or a royer circuit.

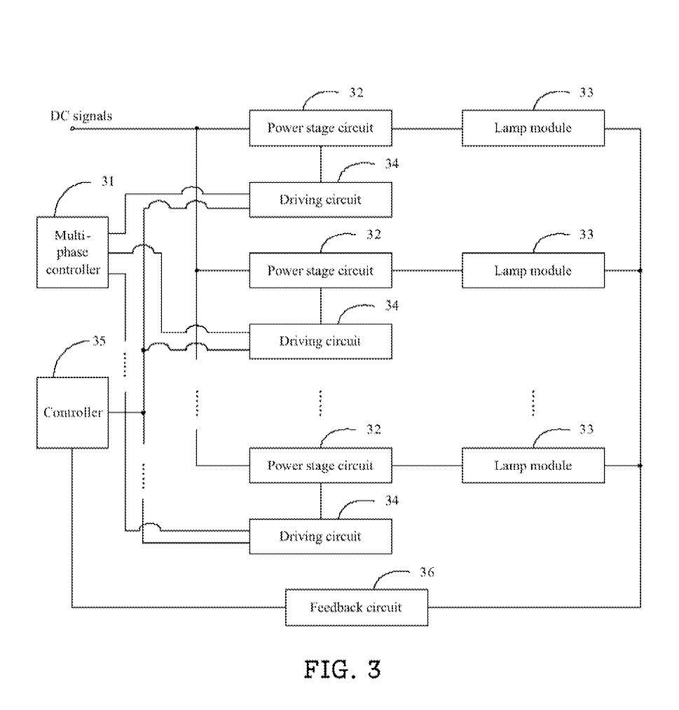

FIG. 3 is a block diagram of a discharge lamp driving device of another exemplary embodiment of the present invention. The discharge lamp driving device includes a multi-phase controller 31, a plurality of power stage circuits 32, a plurality of lamp modules 33, a plurality of driving circuits 34, a controller 35, and a feedback circuit 36.

Each of the power stage circuits 32, connected to a corresponding lamp module 33, converts received DC signals to AC signals to drive the corresponding lamp module 33. Each of the driving circuits 34, connected to a corresponding power stage circuit 32, outputs driving signals to control outputs of the corresponding power stage circuit 32, thereby controlling current flowing through the corresponding lamp module 33. The feedback circuit 36, connected between the lamp modules 33 and the controller 35, feeds back the current flowing through the lamp modules 33 to the controller 35.

In the exemplary embodiment, the received DC signals are variable, so the current flowing through each lamp module 33 is variable. That is, the current flowing through the lamp modules 32 varies along with the magnitudes of the DC signals. The feedback circuit 36 feeds back the current flowing through the lamp modules 33 to stabilize the current flowing through the lamp modules 33 without varying with the DC signals, and thus, even if the DC signals vary, the discharge lamp driving device can provide uniform brightness to a LCD panel and make discharge lamps of the lamp modules 33 work normally. The discharge lamp driving device of this embodiment is a closed loop.

The controller 35, connected to the driving circuits 34, controls duty cycles of the driving signals output by the driving circuits 34 according to the current fed back by the feedback circuit 36, thereby controlling outputs of the power stage circuits 32. In the exemplary embodiment, the controller 35 may include a pulse width modulation (PWM) controller. The controller 35 can further adjust the current flowing through the lamp module 33 to ensure a constant current source, regardless of the variation in voltage value of the DC signals.

The multi-phase controller 31, connected to the driving circuits 34, controls timing of driving circuits 34 outputting the driving signals to sequentially light the lamp modules 23 so that not all the lamp modules 23 are lit simultaneously.

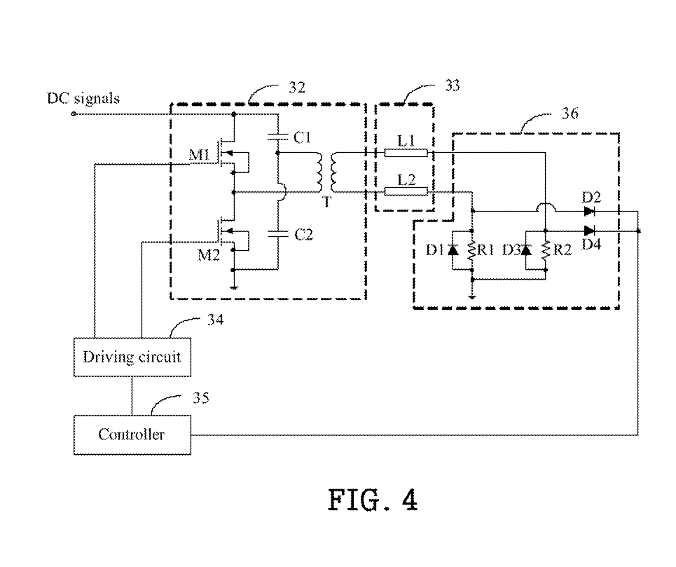

FIG. 4 is a circuit diagram of the power stage circuit 32, the lamp module 33, and the feedback circuit 36 of FIG. 3. The circuit diagrams of the power stage circuit 32 and the lamp module 33 of this embodiment is the same as the circuit diagram of the power stage circuit 22 and the lamp module 23 of FIG. 2, so descriptions are omitted. In the exemplary embodiment, the feedback circuit 36 includes a plurality of diodes D1, D2, D3, and D4, and two resistors R1 and R2. The resistors R1 and R2 are respectively connected between lamps L1 and L2 and the ground. The diode D1 and the resistor R1 are connected in parallel, and an anode of the diode D1 is grounded. The diode D3 and the resistor R2 are connected in parallel, and an anode of the diode D3 is grounded. An anode of the diode D2 is connected to a cathode of the diode D1. An anode of the diode D4 is connected to a cathode of the diode D3. Cathodes of the diodes D2 and D4 are connected to the controller 35 as an output of the feedback circuit 36.

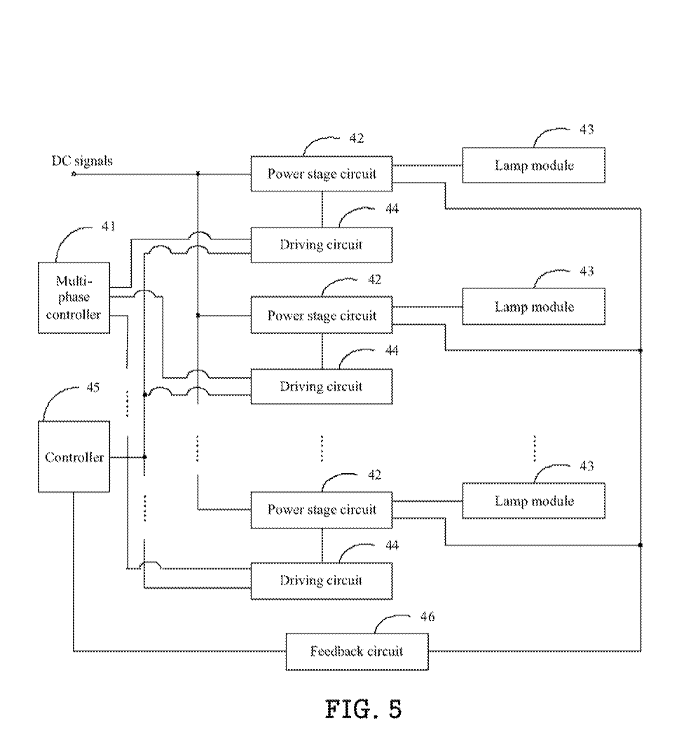

FIG. 5 is a block diagram of a discharge lamp driving device of a further exemplary embodiment. The discharge lamp driving device of this embodiment is similar to the discharge lamp driving device of FIG. 3. The difference between the discharge lamp driving device of this embodiment and that of FIG. 3 is that each feedback circuit 46 is connected between the corresponding power stage circuit 42 and the controller 45, and the feedback circuit 46 feeds back current flowing through the lamp module 43 via the power stage circuits 42 to the controller 45.

Thus, the discharge lamp driving device of the invention employs a controller to control a plurality of lamp modules, and can select different types of controllers according to received DC signals, in order to adapt to different types of circuit architectures. Accordingly, the cost of the discharge lamp driving device is reduced, and the architecture of the discharge lamp driving device is simplified.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A discharge lamp driving device, for driving a plurality of lamp modules, comprising:
a plurality of power stage circuits, respectively corresponding to the lamp modules, for converting received direct current (DC) signals to alternating current (AC) signals to drive the corresponding lamp modules;
a plurality of driving circuits, respectively connected to corresponding power stage circuits, for outputting driving signals to control outputs of the corresponding power stage circuits;
a multi-phase controller, connected to the driving circuits, for controlling timing of the driving circuits outputting the driving signals; and
a controller, connected to the driving circuits, for controlling duty cycles of the driving signals.

2. The discharge lamp driving device as claimed in claim 1, wherein the received DC signals are stable.

3. The discharge lamp driving device as claimed in claim 2, wherein the controller comprises a bus controller, for controlling the duty cycles of the driving signals according to variable frequencies of the bus controller.

4. The discharge lamp driving device as claimed in claim 1, wherein the received DC signals are variable.

5. The discharge lamp driving device as claimed in claim 4, wherein the controller comprises a pulse width modulation (PWN) controller.

6. The discharge lamp driving device as claimed in claim 5, further comprising a feedback circuit, for feeding back current flowing through the lamp modules to the controller.

7. The discharge lamp driving device as claimed in claim 6, wherein the feedback circuit is connected between the lamp modules and the controller.

8. The discharge lamp driving device as claimed in claim 6, wherein the feedback circuit is connected between the power stage circuits and the controller.

9. A device for driving a plurality of lamp modules, comprising:
a plurality of power stage circuits electrically connectable with a plurality of lamp modules to provide power to said plurality of lamp modules for illumination thereof, respectively;
a plurality of driving circuits respectively electrically connectable with corresponding ones of said plurality of power stage circuits so as to provide driving signals to control power outputs of said corresponding ones of said plurality of power stage circuits;
a multi-phase controller electrically connectable with said plurality of driving circuits, respectively, to differentiate output timing of said driving signals from said plurality of driving circuits; and
a controller electrically connectable with said plurality of driving circuits, respectively, to simultaneously control duty cycles of said driving signals from said plurality of driving circuits.

10. A device for driving a plurality of lamp modules, comprising:
a plurality of power stage circuits electrically connectable with a plurality of lamp modules, respectively, to provide power to said plurality of lamp modules for illumination thereof;
a plurality of driving circuits respectively electrically connectable with corresponding ones of said plurality of power stage circuits so as to provide driving signals to control power outputs of said corresponding one of said plurality of power stage circuits;
a multi-phase controller electrically connectable with each of said plurality of driving circuits to respectively control output timing of said driving signals from said each of said plurality of driving circuits; and
a controller electrically connectable with said each of said plurality of driving circuits to commonly control duty cycles of said driving signals from said each of said plurality of driving circuits.
